(19) United States
(12) Patent Application Publication
(10) Pub. No.: US 2002/0026388 A1
(43) Pub. Date: Feb. 28, 2002

(54) Method of distributing a product, providing incentives to a consumer, and collecting data on the activities of a consumer

(76) Inventor: Chris Roebuck, Toronto (CA)

Correspondence Address: Stephen M. Beney, Bereskin & Parr, Box 401, 40 King Street West, Toronto, ON, M5H 3Y2, CA

(21) Appl. No.: 09/919,601

(22) Filed: Aug. 1, 2001

Related U.S. Application Data
(60) Provisional application No. 60/222,327, filed on Aug. 1, 2000.

(51) Int. Cl. G06F 17/60

(52) U.S. Cl. 705/27

(57) ABSTRACT

In one aspect, the invention relates to a method of distributing a product. The method includes creating a virtual representation of the product, including a virtual three-dimensional model of the product, displaying the virtual representation of the product in a virtual world where the representation is available for viewing, enabling a selecting person who selects the virtual representation to view in three dimensions the three-dimensional model of the product, and conveying information about the product to the selecting person.

### FIELD OF THE INVENTION

This invention relates to distributing products. This invention also relates to providing incentives to a consumer to purchase a product, and to collecting data concerning the activities of a consumer.

### BACKGROUND OF THE INVENTION

It is known in the art to enable purchasers to purchase products by shopping for the products virtually by connecting a vendor's web site. There is a continuing need, however for new methods for distributing products.

### SUMMARY OF THE INVENTION

The present invention is directed to a method of distributing a product, and particularly to a consumer of the product. In general, the method comprises creating a virtual representation of the product. The virtual representation comprises a virtual three-dimensional model of the product, but can also include a further representation that links to the product, for example, a pamphlet or flyer that refers to the product. The virtual representation of the product is displayed in a virtual world where the representation is available for viewing by persons in the virtual world. Any person who selects the virtual representation of the product, hereinafter referred to as the selecting person, will be able to view in three dimensions the three-dimensional model of the product. In addition, the selecting person is provided with information about the product.

For purposes of this application a virtual world can include, for example, but not limited to, a virtual city, store, gaming world, apartment, house, or other dwelling.

In a preferred embodiment of the invention the virtual representation is animated. In addition, the three-dimensional model of the product is animated.

Moreover, in a preferred embodiment of the invention when the selecting person selects the virtual representation of the product, the selecting person is able to manipulate the three dimensional model of the product to present a different view of the product.

In a preferred embodiment of the invention the virtual representation of the product is displayed in a virtual store in the virtual world. The virtual store can be sponsored by a vendor of the product.

In a preferred embodiment of the invention the select information comprises purchase information, such as, for example, an e-commerce enabled web site.

Further, in a preferred embodiment of the invention the selecting person can navigate through the virtual world. In particular, the selecting person navigates through the virtual world by moving a virtual representation (commonly referred to as an avatar) of the selecting person through the virtual world. As the selecting person navigates through and interacts with the virtual world, the selecting persons activities are recorded, for example, but not limited to, noting product interests, buying habits, and location interests within the virtual world. The recorded activities can be compiled and provided to a vendor of the product.

The above methods of the preferred embodiment of the invention can be used to provide incentives to a selecting person to purchase a product of a vendor. In particular, a benefit is conferred on the selecting person who wants to acquire the product. The benefit is obtained by having the selecting person navigate through and interact with the virtual world. In a preferred embodiment of the invention the benefit is the enablement of the selecting person to acquire the product at less than a usual cost fur similar products not selected in the virtual world. For example, the benefit can be in the form of virtual dollars to be applied against a purchase cost for the product. The virtual dollars would be earned by the selecting person navigating through and interacting with the virtual world, for example, playing a game or working a virtual job.

Certain promotions cane be sponsored by vendors for certain products, for example, the benefit could be the enablement of the selecting person to acquire the product at no cost. Other promotions could have, for example, the benefit comprising a donation made to a charitable organization, and possibly of the selecting persons choice.

Further, a method of collecting activities in a virtual world of a selecting person of a product for use by a vendor of the product is also disclosed. In particular, as previously mentioned, the activities of the selecting person are recorded as the selecting person navigates through and interacts with the virtual world.

### BRIEF DESCRIPTION OF THE DRAWINGS

The present invention will now be described by way of example only with reference to the attached drawings in which;

FIG. 1 is a chart illustrating a method for marketing, viewing and selling of products and services in accordance with a first embodiment of the present invention,

FIG. 2 is a chart illustrating a method for marketing, viewing and selling of products and services in accordance with another embodiment of the present invention;

FIG. 3 is a chart illustrating a method for marketing, viewing and selling of products and services in accordance with yet another embodiment of the present invention;

FIG. 4 is a chart illustrating a method for signing up for the use of the system shown in FIGS. 1, 2 and 3; and

FIG. 5 is a chart illustrating a game in accordance with yet another embodiment of the present invention.

### DESCRIPTION OF THE PREFERRED EMBODIMENTS

“3-D Virtual Reality Web Based Community”

This invention relates to distributing products. This invention also relates to providing incentives to a consumer to purchase a product, and to collecting data concerning the activities of a consumer. In particular, this invention uses three-dimensional computer generated graphics and content with a specific theme (but not limited to that theme) on an Internet web site or computer network, for the purpose of creating a virtual world or online club or community of connected members who can identify each other, see products they can purchase or get information about, play games, be educated, explore a pre-designed and/or customizable virtual living space, and any other real, surreal, or created place.

The three-dimensional graphics of the virtual world can be created using computer generated graphics software. The method of the invention also contemplates displaying the three dimensional computer generated graphics to create the impression for a member that he or she is moving within the computer generated virtual reality space, or that he or she is having some effect on other three-dimensional computer graphic objects or avatars within the virtual world.

### General Technical Description

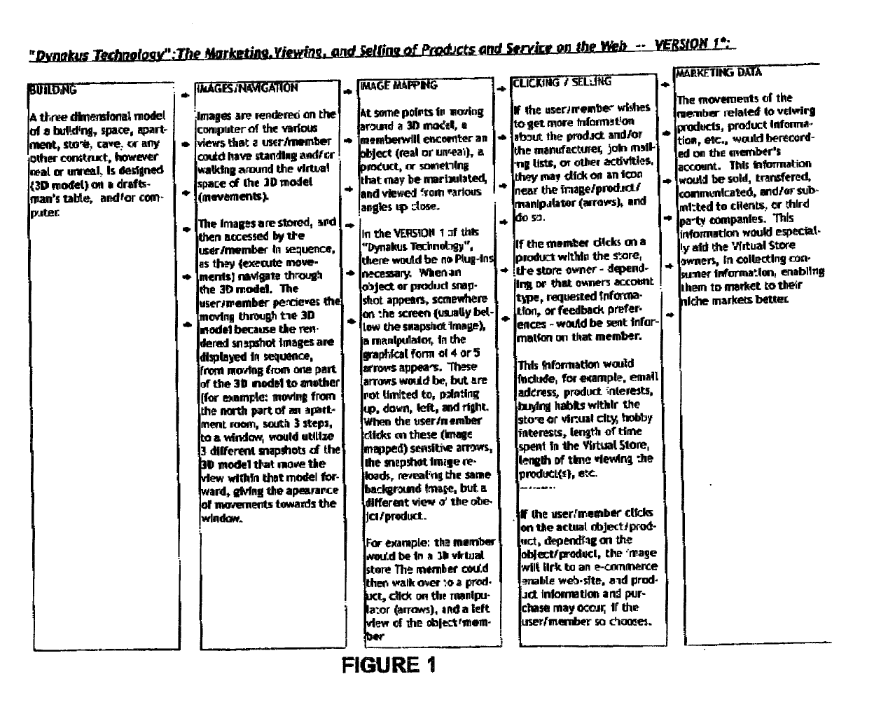

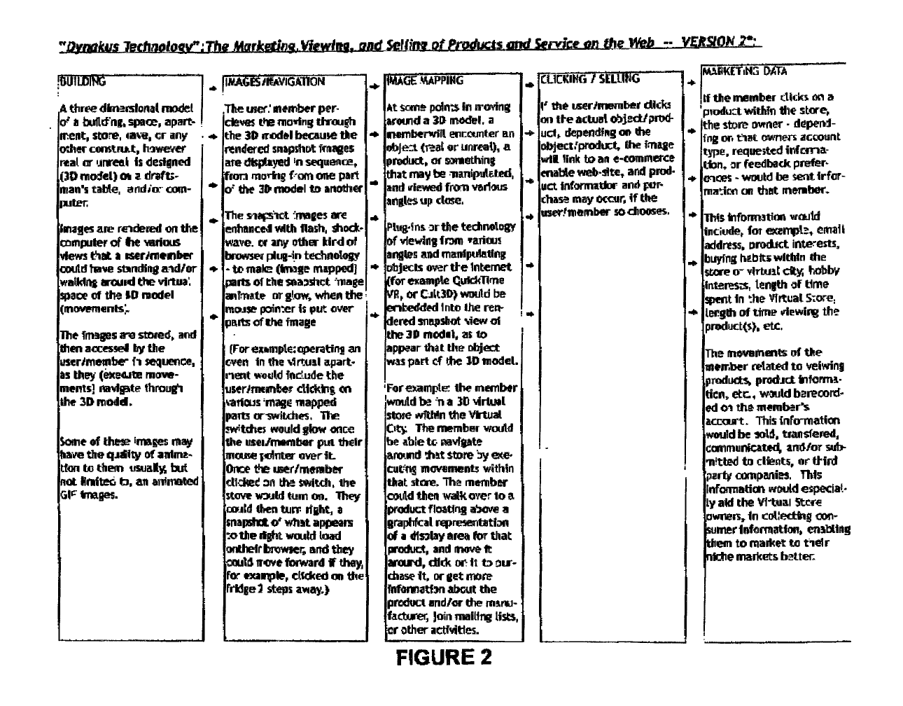

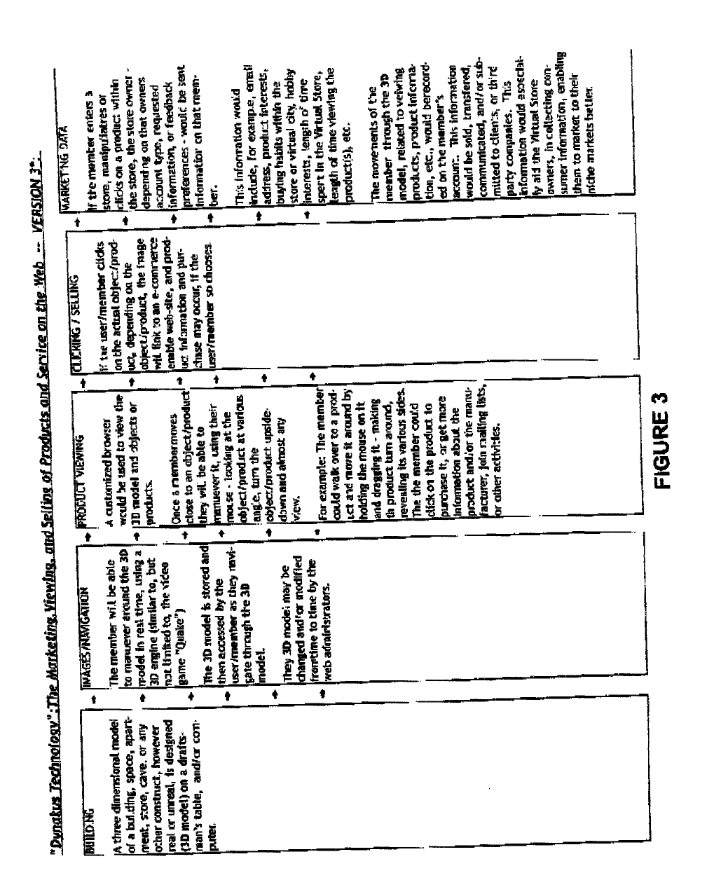

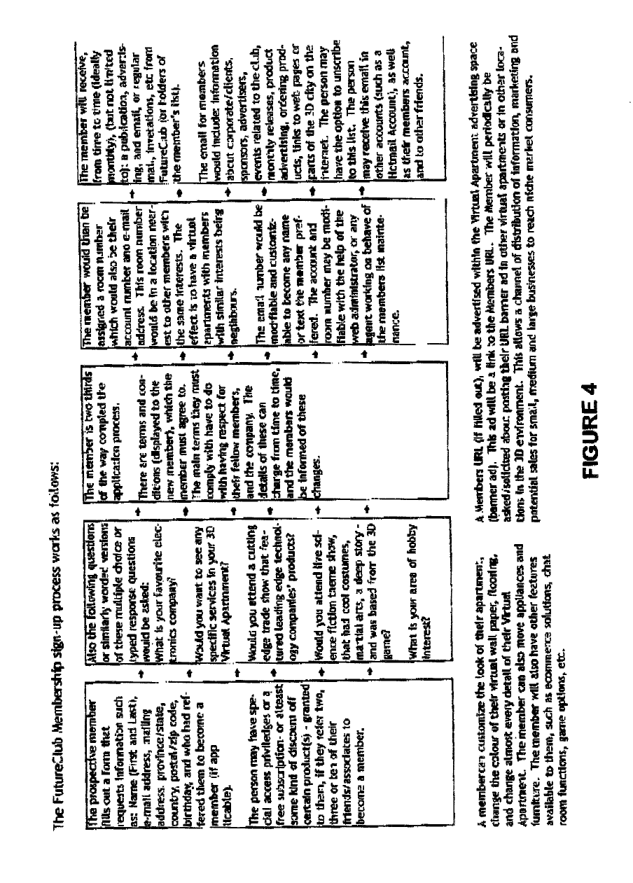

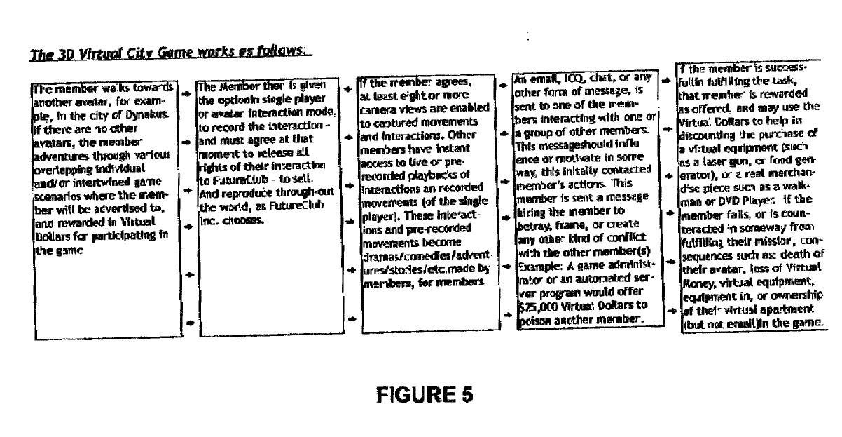

Reference is made generally to FIGS. 1, 2, 3, 4 and 5. The method of displaying three-dimensional computer generated graphics and content is as follows. Programmers produce three-dimensional computer generated graphics images, programming, and information for members to access on the an Internet web site or computer network server with the three-dimensional computer generated graphics images, programming, and information stored on a server hard-drive or any other data reading device. A person will log-on to the server and enter information which is sent to tho server. The information can be prompted, for example, questions such as Name and/or ID code, password, e mail address, address Information, and market information oriented questions. The person joins a membership list for a fee or for free, depending on the membership package, and fills out information such as, for example, but not limited to, information about themselves, content preferences, product preferences, game style and theme preferences, educational preferences, personal preferences (such as favourite colour, food, music, etc.), and other information. This information is saved on the server in the form of a database of member information that includes, for example, but not limited to, the status of an avatar belonging to that member and details of their customized or pre-designed virtual apartment.

The member may also be required to fill out a form, similar to a personal matchmaking questionnaire. The questionnaire would gather consumer information, for example, but not limited to: buying habits, income, interests, and preferred products. Market tests may be executed at this time, with the member being the source of statistical information/answers. The tests may be carried out by a third party company.

The member could be given the option of signing up as either a free member or a paid member. Membership fees and features may change from time-to-time, depending on the situation. An ID Code may be assigned, and/or chosen, and/or altered, by the member.

Once joined as a member, the person will receive access to a three-dimensional computer generated graphical: apartment, cave, house, condominium, or other type of dwelling, located in a three-dimensional virtual world. The server loads the requested graphic file of the virtual apartment. The member will also have the three-dimensional computer generated graphics images of the virtual world available to them from the server.

Using a mouse, stylus, touch pad, or any other kind of motion sensitive device, a member can direct the movement of their avatar in various directions, and initiate various actions within the virtual world. The member will generally start their navigation in their virtual apartment. Movements that a member may execute in the virtual world are (but not limited to): forward, left, right, back, looking up, looking down, pick-up object, put down object, add to inventory, check, check mail, check finances, check personal profile, purchase, use, see inventory, teleport, use MTL, use Moleculon® Transonic Locator, use MMR, use Moleculon® Mono Rail, see, see KR Show, see DeepMajic (TM), see entertainment, play game, go shopping, go to my pad, go to my home, go to my mail, check ThreeDMoney, exit, or quit.

After receiving direction from a member to direct specific graphical displays of a three-dimensional view of a place, building, space, city, vehicle, apartment, house, or any other graphically recreated three-dimensional computer rendered image or place, real or unreal, the computer of the member, and in-turn, the video output device (monitor, screen, stereoscopic-like goggles, or any other viewing device) of the member, displays an image that logically and spatially connects from the previous image to give the illusion of movement through a three-dimensional space and/or of affecting a three-dimensional object, person/member, animal, or any other three-dimensional object.

The member can visit his or her own virtual apartment, virtual stores, and other cities, in the virtual world. These locations can be designed by third parties who have a contract to perform such work,

The viewing, hearing, interacting, and/or experiencing in the virtual world could also be added as an option by using a “Portable Wireless VR” unit which will receive, via, but not limited to, wireless telecommunications and/or Internet. Other Internet tools, executable actions and/or elements, that are used within the virtual world include, but are not limited to, such tools/things/programs/utilities/plug-ins/etc. described below.

### Three-Dimensional Graphics Images Processing and Production

Three-dimensional software or workstation are used to design a three-dimensional place, building, space, city, vehicle, apartment house, or any other graphically recreated three-dimensional computer rendered image or place, real or unreal, and rendering or having the computer draw the snapshots of these images, so that they may be followed in a logical and continuing order. As the member controls their avatar, for example to walk forward, one step at a time, the member will in effect be loading and viewing snapshots taken from a pie-rendered (or real-time rendered) server. The member may, for example, move through the three-dimensional place at increments of 5 feet as the images would appear to a member.

### Photanimation

The process of taking a real life image, and transferring it into an anime, computer 3D graphic, or any other style of cartoon image, by altering the shading, texture, look, etc. of the image; either digitally, by hand, or by other means of artistic alteration and modification (such as putting tho image of a photograph through a filter in a digital image editing software packages such as Adobe® PhotoShop®, and altering the image to appear similar to a Japanese Anime/Manga style drawing or cartoon cell.

### Anime-Recl

The process of taking a real life video taped, filmed, or motion captured images, movements, or live action, and transferring it into an anime, computer 3D graphic, or any other style of cartoon image, by altering the shading, texture, look, etc. of tho image; either digitally, by hand, or by other means of artistic alteration and modification (such as putting the images of a film through a filter in a digital image editing software packages such as Adobe PhotoShop, and altering the image to appear similar to a Japanese Anime/Manga style drawing or cartoon cell.

### Marketing/informal Description

A method of entertaining, selling, and marketing to people on the Internet is disclosed. The method includes a person joining, (referred to as member), accessing the Internet and going into a virtual reality space within a virtual world, individually explored by the (member or shared by the other members simultaneously. The virtual world is a computer generated three-dimensional graphical space, which, in a preferred embodiment appears on any computer screen, or display device of any kind. The members can execute movements, view, hear, buy, sell, market, interact, or otherwise experience the Internet in a three dimensional visual, auditory, binaural, or graphical way, in the virtual world. The virtual world can include, various enhancements. For example, three-dimensional virtual stores and online shopping areas, online three-dimensional virtual gaming areas, a virtual apartment or living space areas, educational areas (ThreeD Academy), entertainment promoting areas (“KR-The Sci-Fi Musical), and miscellaneous contents area.

The virtual world Is a virtual place where a person or persons using a computer and/or the Internet, joins a club as a member, and may participate, in various ways or process, in the virtual world using, for example, a specialized browser, or commercially available browser with specialized software plug-ins. The ways or process of interacting in the virtual world comprise:

Controlling the view point of the member, through the virtual eyes of a member's avatar (or other three-dimensional representation of the member) and eight or more outside camera views of the member's avatar (or other three-dimensional representation of the member);

These viewpoints (mentioned above) are captured by a specialized 3-D rendering program which sends or broadcasts those various views to the member, in real-time, through a kiosk or computer terminal, on a network, and/or through the Internet, and displayed to that member in real-time or at a connection or communication speed preference chosen by the member or chosen by the server which is sending the member these viewpoints;

Controlling the movements and viewpoints of the representation of a member's avatar (or other three-dimensional representation of the member);

Controlling that (above mentioned) view, exploring various elements within that “3-D Virtual Reality Web Based Community” described in the Enhancements section;

Pointing at 3-D objects, locations, doorways, buildings, or any other graphical representation of a real, surreal, abstract, or semi-real 3-D place, creature, object, person or thing, within the virtual world, with a mouse, stylus, touch pad, or any other kind of motion sensitive device (such as movement detecting glove device/controller)—and moving towards or away from those 3-D objects, locations, doorways, buildings, or any other graphical representations or affecting the movement or graphical representation of them in some way:

Interacting with other 3-D graphics and/or with 3-D objects (by picking them up, looking at them from various angles, or Interactive in any way with any object, including, but without limitation, using an Internet plug-in technology such as “QuickTime VR, Cult3D, a specialized plug-in, or any other type of software which allows a similar function) within the virtual world; and

Interacting with other members also in the virtual world or system operators, in any form that presents those other members and/or any 3-D representation of a human being, creature, animal or being or other object.

### Service-Building the Virtual World

“Enhancements” are all features that work within or in co-ordination with the virtual world. Each “Enhancements” features a specific approach, graphical display, interaction between technology, or is a software, hardware, or other tool, which adds to, interacts with, displays, or in some way represents, sells (the memberships of) or markets (the membership of) the virtual world—and is all part of this method of viewing, hearing, interacting, and/or experiencing the Internet or a specialized network displaying and/or allowing access to the virtual world.

### ThreeD City

### www.ThreeDcity.com

Threed, ThreeD, or ThreeD City—This is any city, virtual reality place, or virtual world that is created in a three dimensional computer program, or any other hardware or software based system, which is used by any persons, in any country: to display, sell, advertise sellable/non-sellable, or even non-real objects, on a network, the Internet, or any other form of electronic media. Other Internet tools, executable actions and/or elements, that are used within the virtual world include, but are not limited to, such tools/things/programs/utilities/plug-ins/etc. as:

e-commerce;

any type of monetary transactions;

accessing and/or being able to alter, or affect in anyway;

personal, product, business, or any other form of information;

accessing and/or being able to alter, or affect in anyway;

e-mail messages and account information;

chatting with other users/members;

watching video and/or listening to audio of any kind, including streaming audio and/or video information; and

watching any members and/or their interaction with one another, in the virtual world.

The further ways or processes of interacting in the virtual world are:

Controlling that (above mentioned) view, exploring various elements within the virtual world, such as

Viewing and navigating around a virtual store (see ThreeD Stores)—moving around in that store in that virtual space and picking up and looking at that virtual stores products—which can lead to the access of more information on that three-dimensional version of that product and/or the purchase of that product, by the members clicking on that product or a related link of that product.

### The Virtual Apartments-Center of the Virtual World

### (www.virtualapartments.net or www.ThreeDapartments.com)

A members 3-D graphical environment is relatively unique from other members 3-D graphical environments, in that it is a different address or graphical representation of an address of an apartment, cave, house, condominium, or other type of dwelling, located in a three-dimensional model (generally of a city, town, or similar locale). This assigned three-dimensional space has its own viewpoint, (for example, a window), to look out from, at the rest of the virtual world.

Unique features about a member's three-dimensional computer generated graphical apartment, cave, house, condominium, or other type of dwelling, located in a three-dimensional virtual world can include, but not limited to:

Members are located in predetermined areas or the various three-dimensional buildings, which make up the virtual apartments and virtual world.

Member with the same interests, likes, dislikes, etc. (as researched through answers given in the Members' application questionnaire) are placed together as neighbours within these virtual apartment communities. A member will own one or the virtual apartments, situated near other consumers who share similar interests.

Members will find that in their virtual apartment, they can walk out to a virtual balcony and have their own view. This means that each apartment will have the novelty of its own unique view/angle of ThreeD City and the surrounding landscape. In the prototype version of virtual apartments, there are 500 different views from one building, which can expand to more or less, depending on the three-dimensional structure designed.

The member has the option to, at times, see the other members' avatars and, If they choose, interact with them through an Internet chat line, or existing technology chat line, such as an “ICQ” within the virtual apartments, game, or virtual world.

The ways or process of interacting in the virtual world virtual apartments are by viewing and navigating within that space, and accessing the following modifiable features:

### ThreeD PC/ThreeD Mac/ThreeD All Access

A member chooses a three-dimensional model of a computer or laptop computer (computer) from the server's database. The members computer can access and display the member's or an existing/third party e-mail account, bank account, or other files of personal or business contents (such as an FTP Servers files). The information, would be displayed the same way as the ThreeD Mail; displayed in three-dimensional graphics, to appear as if the contents, text, and/or graphics are being displayed on a three-dimensional graphic of a computer, monitor, or any other kind of transmitter of optical information.

### ThreeD Mail

Any e-mail account, or third party company supplying e-mail, which is filtered through the ThreeD PC/ThreeD Mac/ThreeD All Access, and displayed in three-dimensional graphic to appear as if the contents, text, and/or graphics are being displayed on a three-dimensional graphic of a computer, monitor, or any other kind of transmitter of optical information (within that three-dimensional computer graphic of tho virtual apartments or virtual world).

### ThreeD TV

Streaming video and audio information, from any outsourced, developed technology, such as “Real Networks”, or “QuirkTime.” The video and audio information would be graphically embedded into a three-dimensional computer generated model of an object, such as a television set, giving the illusion to members, that they are viewing the video and audio information on a device similar to a television, within their virtual apartment or virtual world.

### ThreeD Radio

Streaming audio information, from any outsourced, developed technology, such as “Real Networks.” The audio information would be embedded into a three-dimensional computer generated model of a radio or stereo system, giving the illusion to members, that they are listening to the programming on a device similar to a radio or stereo system, within their virtual apartment or virtual world. An example of audio information includes music, ads, morning “Funnies Show,” and other entertainment content.

### Vurniture

### (Virtual Furniture Models by Design or Third Party Company)

The three-dimensional graphical representation of furniture, real (and made by a third party furniture manufacturer), or created from a three-dimensional computer graphics designer, which is located within a members virtual apartment or virtual world. Examples of Vurniture would be appliances, electronics, and consumables for a potential buyer. The virtual apartments will come with these creatively modified living space furnishings, as well as other additions not generally found in real physical apartments.

### Members E-Mail Newsletter

### FutureClub E-Zine

### wwwfutureclub.net, www.futureclub.org

A monthly, but not limited to any specific time frame, electronic magazine, can be circulated to members who, for example, subscribe to it. Further, a FutureClub E-Zine contents could initially be a limited version of the content in a FutureCliub Magazine and CD, for example. This newsletter sent via e-mail will give a brief amount of information on entertainment, the ThreeD City and events in the virtual world, and the Virtual Online Games, but full information on Virtual Stores, and/or other created content.

### ThreeD Stores

For any manufacturer, retail, or other seller of goods, an e-commerce enabled store can be set-up in the virtual world. The ThreeD Stores are located immediately after exiting, or nearby the virtual apartments. If a members virtual apartment is further away, they can use the MTL (or Hot Buttons) to teleport or can use the Moleculon Mono Rail to travel within the virtual environment to the ThreeD City center, where there are the (e-commerce enabled) ThreeD Stores.

### ThreeD Academy

In the three-dimensional computer generated graphic model of the virtual world, a member may visit a segment of ThreeD City which is dedicated to teaching educational lessons. This area (herein referred to as: ThreeD Academy) can have three-dimensional computer graphical representations of school buildings, with classrooms. In these virtual reality based classrooms, a member may download a form of live or prerecorded educational information, in the form of, but not limited to, text, audio files, video files, or streaming video and/or audio files).

### The Shopping Bookmark

A (physically real) merchandise product can be bookmarked in the ThreeD Stores, or at actual physical store or purchasing locations, and bought at a later time through the members credit card or bank account, in the virtual apartment, or in any other location where the members Shopping Bookmark is accessible.

### ThreeD Banking

The Virtual Apartment and various parts of ThreeD City within the virtual world will be enabled with Virtual Banking through pre-established banking institution channels. For example the “PLUS” bank account-accessing system. ThreeD Bankinq will enable members to access their bank accounts, do transactions, purchase stocks, e-mutual funds, etc. The other part of the technology is that it ties In the e-commerce purchasing of actual items in ThreeD Stores, and allows the member to purchase the item through the member's own bank account. This e-commerce/bank transaction can take place either directly online, in the virtual store, in the virtual apartment (through the use of the Shopping Bookmark), at a physical kiosk located at any physical location, within the apartment or in the Virtual Stores in “ThreeD City.”

### 3-D Online Gaming-Simple Games (Mystery to Arcade Games) and Complex Interactive Games (DarkMagic, Dynakus, KR, K. R., K. R, DM, DarkMagic.com) www.darkmagic.com, www.dynakus.com. www.dynakus.net, www.dynakus.org

The online gaming areas of the virtual world. Either part of ThreeD City or a separate locale on their own, such as Dynakus and DarkMagic. The online games take the form of mystery games, shooting weapons games, mission games, puzzle games, and arcade games. They are completely separate games, or intertwined games, with story plots connecting to each part and/or style.

### Mystery Games

Involves the member being placed in a pre-set scenario, where they must solve a specific mystery, such as discovering the killer in a murder, a thief, or the like.

### Shooing Weapons Games

Involves a member's avatar shooting at, and potentially destroying or temporarily disabling another member's avatar. The member may also opt to play against the server-controlled avatar, a Network Administrator of the server, or another third party avatar controller.

### Mission Games

Involves a member in a game of espionage, where they must control their avatar to complete an assigned mission. For example the member may be asked to collect information, spy on, or destroy another avatar—whether the avatar is controlled by another member, the server, a Network Administrator of the server, or another third party avatar controller.

### Puzzle, Arcade, and Other Games

There are a large variety of other games that the member can have access to, including (licensed) pre-made arcade games, card games, crossword, maze puzzles, and other logic testing games. These would all be seen by the member, through the virtual eyes of the avatar.

### 3-D Interactive Online Game “DarkMagic-Dark High-Tech City”

In “DarkMagic” the member is the hero, or the villain, or who ever the member wants to be. DarkMagic is the name of the underground city, where the most intense game play occurs. The game is a science fiction theme adventure, with the elements of suspense, mystery solving, and action.

“DarkMagic” is the first online game to be released to members, where the world at large can play. Dramas, Espionage, Suspense and Exploration are some of the main aspects of the game. The game has pre-programmed scenarios, at different levels, that keep members coming back for more. These levels can he changed and customized for the member, and also altered by the Network Administrator of the server.

### Brief Scenario Sketch for “DarkMagic”

The game begins In the massive (above ground) Domed City of “Dynakus” (www.dynakus.com), where a mysterious, evil force is slowly taking control of the government, people, and operations of the metropolis. The member's goal in the game scenario would be to discover the source of this evil, and stop it. In the setting of the game, Dynakus City, the member can become a character in the game, and even have a second virtual apartment. If the Member spends all of their online time in the game, then they can be evicted (due to lack of activity) from their apartment in ThreeD City.

There will be a technology in the game works as follows:

The member walks Member then if member agrees to influence further towards another is given the opinion at least eight or more interaction, an e-mail, avatar, for example, To reward the inter- camera angles are enabled ICQ, chat, or any other in the city of Dynakus action-and must to captured the Interaction form of message is sent agree at that moment Other members may have to one of the interacting to release all rights of access to this interaction members, from our their interaction with instantly, or in a playback company or automatically Futureclub-to sell database of previous inter- through the server. For And reproduce through- actions. It becomes a drama example, it would offer out the world, as we made by, and for the masses $25,000 Threed Dollars choose.

### Transportation in the “3-D Virtual Reality Web Based Community” Moleculon®, MTL, Moleculon® Transonic Locator, ThreeD Teleporter, MMR, or Moleculon® Mono Rail

A mode of transporting the avatar, or viewpoint of a member, in the virtual world, from various locales within the three-dimensional computer generated community, to other locales. For example, a member may want to shop in a ThreeD Stores, and then suddenly check e-mail. By pressing a “Teleport” button, the member may link directly to the file, which graphically represents that at virtual reality area within the three-dimensional model or virtual world.

Members have two choices of transportation in the ThreeD City. The primary form of transportation is the fastest; the MTL. This device, which is the members watch in the Virtual World, can zap the member to any area. With the use of Hot Buttons, which act like bookmarks, the member can click to where they wish to be, even though, it may be miles away within the virtual world.

The Moleculon Mono Rail, is the secondary source of transportation for a member's avatar. It will allow members to stop off at different locales. Immediately after exiting the virtual apartments a member could take the Moleculon Mono Rail to the ThreeD City renter and view various parts of ThreeD City on the way—as opposed to simply appearing in an e-commerce enabled ThreeD Store.

### Products Promotion Through the “3-D Virtual Reality Web Based Community”

### Futureclub Magazine with CD

### www.futureclub.net, www.futureclub.org

This magazine product is a physical magazine, to cross promote the contents of and membership to the virtual world. The magazine is a combination of, but not limited to, Comic Book, Entertainment Magazine, Web-Site Information Report, Product and/or Sponsor Advertising Booklet, Educational Review, and Computer 3D Video Game Magazine. The magazine will usually, but not always, be accompanied by a Compact Discs, DVD, Mini-Disc, or other storage medium (herein referred to as: CD), with, but not limited to, MPEG2 video content, music, graphics, web site demonstrations, pictures, jpeg images, GlF images, and computer programs.

The magazine's contents and subject matter correlates directly with the content in the virtual world, online. For example, if there is an event such as the launch of a new interactive game in “ThreeD City”, then a report would be printed In the magazine, and the CD would have a brief demonstration of that game. The magazine product comes wrapped in a sealed bag or pouch. Before the magazine is put into the bag or pouch, a password would be randomly generated, and printed on a label. The label would be affixed, in some way, to the inside cover of the magazine. The magazine is inserted into the bag or pouch, the bag or pouch is then heat-sealed shut. A randomly generated password will be unique for each set, and found inside the magazine. This number represents a password, for the security feature explained below, and is also a free membership account number.

### The FutureClub Magazine CD - Security Features

The CD product has two features: a security feature, and an “Instant Member-ship” feature.

### Security Feature

The purchaser loads and/or installs the CD contents onto a personal computer, Macintosh computer, PC, or other format of hardware (herein referred to as: personal computer). After the personal computer has installed the software, in order to run the programs and software on the CD, the purchaser of the CD must enter a password, which comes imprinted inside the accompanying magazine. Once the password is entered correctly, the CD can be accessed from that moment on. This will help with reducing CD theft in retail environments, considering a shoplifter would have to take the entire package to get the password that accesses the disk.

### “Instant Membership” Feature

The randomly generated number printed on the label will give access to a free account with the online club, allowing the owner of the CD to explore a virtual apartment, and the virtual world. The CD will allow direct access to this account, if the owner of the disc, by having a browser program, on that CD, connected directly to the accounts web address. The owner would sign-up as a member (as described above).

### MORE ADDENDUMS: Regarding Virtual Apartments

A Members URL (if filled out), will be advertised within the virtual apartment advertising space (banner ad). This ad will be a link to the Members URL. The Member will periodically be asked/solicited about posting their URL banner ad in other virtual apartments or in other locations in the 3D environment. This allows a channel of distribution of information, marketing and potential sales for small, medium and large businesses to reach niche market consumers.

A member can customize the look of their apartment, change the colour of their virtual wall paper, flooring, and change almost every detail of their Virtual Apartment. The member can also move appliances and furniture. The member will also have other features available to them, such as e-commerce solutions, chat room functions, game options, etc.

It can be appreciated that variations to this Invention would be readily apparent to those skilled in the art, and this invention is intended to include these alternatives.

I claim:

1. A method of distributing a product comprising;
a) creating a virtual representation of the product, comprising a virtual three-dimensional model of the product;
b) displaying the virtual representation of the product in a virtual world where the representation is available for viewing;
c) enabling a selecting person who selects the virtual representation to view the three-dimensional model of the product; and
d) conveying information about the product to the selecting person.

2. A method as recited in claim 1 wherein the virtual representation is animated.

3. A method as recited in claim 1 wherein the selecting person can manipulate the three-dimensional model of the product to present a different view of the product.

4. A method as recited in claims 1 or 3 wherein the virtual representation of the product comprises a link to the three-dimensional model.

5. A method as recited in claims 1 or 4 wherein the three-dimensional model is animated.

6. A method as recited in claim 1 wherein the virtual representation of the product is displayed in a virtual store in the virtual world.

7. A method as recited in claim 6 wherein the virtual store can be sponsored by a vendor of the product.

8. A method as recited in claim 1 wherein the select information comprises purchase information.

9. A method as recited in claim 8 wherein the purchase information comprises an e-commerce enabled web site.

10. A method as recited in claim 1 wherein the selecting person can navigate through the virtual world.

11. A method as recited in claim 10 wherein the selecting person navigates through the virtual world by moving a virtual representation of the selecting person through the virtual world.

12. A method as recited in claims 10 or 11 wherein activities of the selecting person in the virtual world are recorded as the virtual representation of the selecting person navigates through and interacts with the virtual world.

13. A method as recited in claim 12 wherein the activities comprise noting product interests.

14. A method as recited in claim 12 wherein the activities comprise buying habits.

15. A method according to claim 12 wherein the activities comprise location interests within the virtual world.

16. A method according to claim 12, wherein the activities are compiled for use by third parties.

17. A method of providing incentives to a selecting person to purchase a product of a vendor, comprising:
a) creating a virtual world:
b) creating a virtual representation of the product, comprising a virtual three-dimensional model of the product;
c) displaying the virtual representation of the product in the virtual world where the representation is available for viewing;
d) enabling a selecting person who selects the virtual representation to view the three-dimensional model of the product;
e) conveying select information about the product to the selecting person; and
f) conferring a benefit on the selecting person who wants to acquire the product by having the selecting person navigate through and interact with the virtual world.

18. A method as recited in claim 17 wherein the benefit is the enablement of the selecting person to acquire the product at less than a usual cost for similar products not selected in the virtual world.

19. A method as recited in claim 18 wherein the benefit is in the form of virtual dollars to be applied against a purchase cost for the product, the virtual dollars earned by navigating through and interacting with the virtual world.

20. A method as recited in claim 18 wherein the benefit is the enablement of the selecting person to acquire the product at no cost.

21. A method as recited in claim 17 wherein the benefit comprises making a donation to a charitable organization.

22. A method as recited in claim 17 wherein the virtual representation is animated.

23. A method as recited in claim 17 wherein the selecting person ran manipulate the three-dimensional model of the product to present a different view of the product.

24. A method as recited in claims 17 or 23 wherein the virtual representation of the product comprises a link to the three-dimensional model.

25. A method as recited in claim 17 wherein the three-dimensional model is animated.

26. A method as recited in claim 17 wherein the select information comprises purchase information.

27. A method as recited in claim 26 wherein the purchase information comprises an e-commerce enabled web site.

28. A method as recited in claim 17 wherein the selecting person navigates through the virtual world by moving a virtual representation of the selecting person through the virtual world.

29. A method as recited in claim 28 wherein activities of the selecting person in the virtual world are recorded as the virtual representation of the selecting person navigates through and interacts with the virtual world.

30. A method as recited in claim 20 wherein the activities comprise noting product interests.

31. A method as recited in claim 20 wherein the activities comprise buying habits.

32. A method according to claim 29 wherein the activities comprise location interests within the virtual world.

33. A method according to any one of claims 28 to 32, wherein the activities compiled for use by third parties.

34. A method of collecting activities in a virtual world of a selecting person of a product for use by a vendor of the product, comprising:
a) creating a virtual world;
b) creating a virtual representation of the product, comprising a virtual three-dimensional model of the product;
c) displaying the virtual representation of the product in the virtual world where the representation is available for viewing;
d) enabling a selecting person who selects the virtual representation to view in three dimensions the three dimensional model of the product;
e) conveying select information about the product to the selecting person;
f) conferring a benefit on the selecting person who wants to acquire the product by having the selecting person navigate through and interact with the virtual world; and
g) recording the activities of the selecting person as the selecting person navigates through and interacts with the virtual world.

35. A method as recited in claim 34 wherein the benefit is the enablement of the selecting person to acquire the product at less than a usual cost for similar products not selected in the virtual world.

36. A method as recited in claim 35 wherein the benefit is in tie form virtual dollars applied against a purchase cost for the products the virtual dollars earned by navigating through and interacting with the virtual world.

37. A method as recited in claim 35 wherein the benefit is the enablement of the selecting person to acquire the product at no cost.

38. A method as recited in claim 34 wherein the benefit comprises making a donation to a charitable organization.

39. A method as recited in claim 34 wherein the virtual representation is animated.

40. A method as recited in claim 34 wherein the selecting person can manipulate the three-dimensional model of the product to present a different view of the product.

41. A method as recited in claims 34 or 40 wherein the virtual representation of the product comprises a link to the three-dimensional model.

42. A method as recited in claims 34 wherein the three-dimensional model is animated.

43. A method as recited in claim 34 wherein the virtual representation of the product is displayed in a virtual store in the virtual world.

44. A method as recited in claim 43 wherein the virtual store can be sponsored by a vendor of the product.

45. A method as recited in claim 34 wherein the select information comprises purchase information.

46. A method as recited in claim 45 wherein the purchase information comprises an e-commerce enabled web site.

47. A method as recited in claim 34 wherein the activities comprise noting product interests.

48. A method as recited in claim 34 wherein the activities comprise buying habits.

49. A method according to claim 34 wherein the activities comprise location interests within the virtual world.

50. A method as recited in claims 1 or 34 wherein the virtual representation of the product is displayed in a virtual apartment.

51. A method as recited in claims 1 or 34 wherein the virtual representation of the product is displayed in a virtual game.

52. A method according to claim 13, wherein the activities are compiled for use by third parties.

53. A method according to claim 14, wherein the activities are compiled for use by third parties.

54. A method according to claim 15, wherein the activities are compiled for use by third parties.

55. A method as recited in claim 24 wherein the three-dimensional model is animated.

56. A method as recited in claim 41 wherein the three-dimensional model is animated.
